(19) United States
(12) Patent Application Publication
(10) Pub. No.: US 2026/0029266 A1
(43) Pub. Date: Jan. 29, 2026

(54) PORTABLE MOUNTING STRUCTURE FOR FLOW METER

(71) Applicant: Cornell Pump Company LLC, Clackamas, OR (US)

(72) Inventors: William James Warren, Boring, OR (US); Erick Arthur Johnson, Gresham, OR (US); Tristan James Kuzma, Gresham, OR (US)

(21) Appl. No.: 19/277,832

(22) Filed: Jul. 23, 2025

Related U.S. Application Data
(60) Provisional application No. 63/674,941, filed on Jul. 24, 2024.

(51) Int. Cl. G01F 15/14; G01F 15/18

(52) U.S. Cl. CPC G01F 15/14; G01F 15/185

(57) ABSTRACT

A compact, fabricated chassis houses an in-line flow meter and supporting electronics. The chassis surrounds the flow meter and houses a large external battery and a solar panel to maintain the battery's charge. The chassis also incorporates an electrical panel that houses a battery that connects to the flow meter. The flow meter is connected on each end to short sections of pipe, within the chassis, that are connected to job-site piping. The short sections may also include ports for additional sensors, which connect back to a monitoring device for remote monitoring. The chassis further includes an adjustable, slotted base plate to accommodate differently-sized flow meters for different applications. The chassis may be formed as stackable unit with alignment pins to guide placement and prevent slippage.

### CLAIM OF PRIORITY

This application claims priority under 35 USC § 119 (e) to U.S. Patent Application Ser. No. 63/674,941, filed on Jul. 24, 2024, the entire contents of which are hereby incorporated by reference.

### BACKGROUND OF THE INVENTION

In-line flow meters, such as electromagnetic flow meters, are used to measure the flow rate of fluid traveling through a pipe. Such meters typically have flanges at either end that are installed between sections of piping in a system to be monitored. In some instances, flow meters may be used in temporary applications, which requires transporting, connecting, and disconnecting the flow meter at different job sites. In many installations, the flow meter is installed in remote locations without convenient access to wired electrical power.

### BRIEF DESCRIPTION OF THE DRAWINGS

FIGS. 1A and 1B are front and rear perspective views, respectively, of an exemplary embodiment of a portable flow meter assembly, according to an implementation described herein;

FIGS. 2A and 2B are front and rear views, respectively, of the portable flow meter assembly of FIGS. 1A and 1B;

FIG. 3 is a bottom view of the portable flow meter assembly of FIGS. 1A and 1B;

FIG. 4 is an assembly view of a chassis of a flow meter assembly;

FIG. 5 is a perspective view of a bracket for use with the chassis of FIG. 4;

FIG. 6 is a front view of a portable flow meter assembly, according to another implementation described herein;

FIG. 7 is a diagram illustrating exemplary connections of components of a pump monitoring system according to an implementation described herein;

FIG. 8 is a diagram of an environment in which systems and methods described herein may be implemented;

FIG. 9 is a flow diagram of an exemplary process for operating a flow meter assembly, according to an implementation; and

FIG. 10 is a flow diagram of an exemplary process for configuring a portable flow meter assembly, according to an implementation.

### DETAILED DESCRIPTION

The following detailed description refers to the accompanying drawings. The same reference numbers in different drawings may identify the same or similar elements. Also, the following detailed description does not limit the invention.

In-line flow meters, such as electromagnetic flow meters, are used to measure the flow rate of a fluid traveling through a pipe. These meters typically have flanges at each end and are installed in-line with pipes of a system to be monitored. In temporary applications, such as rental use and during construction, the flow meter is susceptible to damage when connecting and disconnecting the flow meter, as well as when being transported between projects or job sites. Most flow meters also require a user to be on site near the flow meter in order to read the measured flow rate. Additionally, while many flow meters have an on-board battery to provide the meter with power, the battery must be replaced or re-charged when the battery is depleted. Alternatively, existing meters must be directly hardwired to an external, continuous power source. There remains a need for an in-line flow meter that is portable, protected, self-sustaining, and convenient to use in work site conditions.

Implementations described herein provide a compact, fabricated frame structure (referred to herein as a chassis) to house an in-line flow meter and supporting electronics. The chassis surrounds (or forms a frame around) the flow meter, protecting it from damage during use and transport. The chassis may also house a large external battery source and a solar panel to maintain the battery's charge. The chassis may also incorporate an electrical panel that houses a monitoring device that connects to the flow meter. The monitoring device can enable a remote display of the flow rate and accumulated flow over a wireless connection. The flow meter may be connected on each end, via flanges, to short sections of pipe within the chassis. These short sections further protect the flow meter, as users at a work site can connect additional piping to the short sections rather than directly to the meter. The short sections may also include tapped ports for connecting additional sensors, such as pressure or temperature sensors, which can be connected to the monitoring device for remote monitoring.

In one implementation, the chassis includes forklift pockets and lifting points in order to easily and safely transport the entire fabricated chassis, with flow meter intact, from site to site while protecting the meter and electrical components within. The chassis may further include an adjustable, slotted base plate to accommodate differently-sized flow meters for different applications. In some implementations, the chassis may be formed as stackable unit with alignment pins to guide placement and prevent slippage between stacked units.

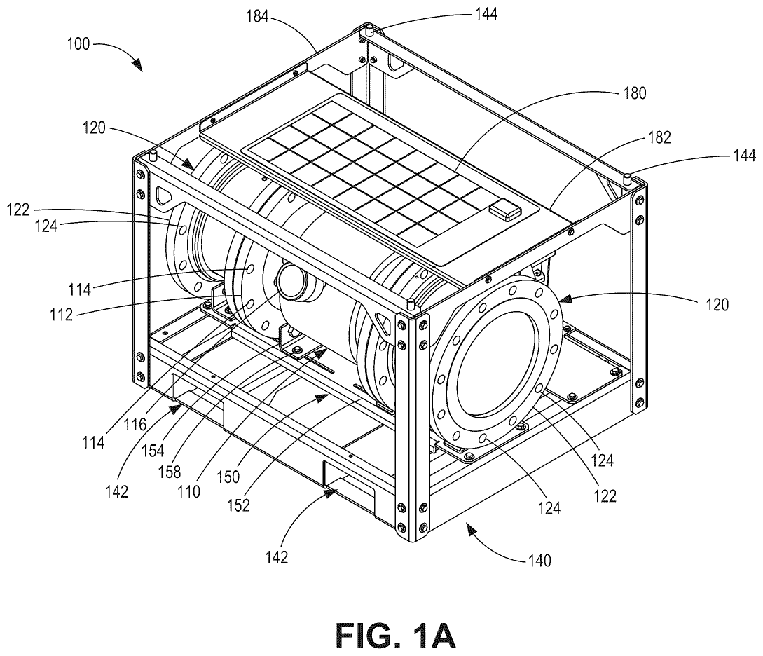

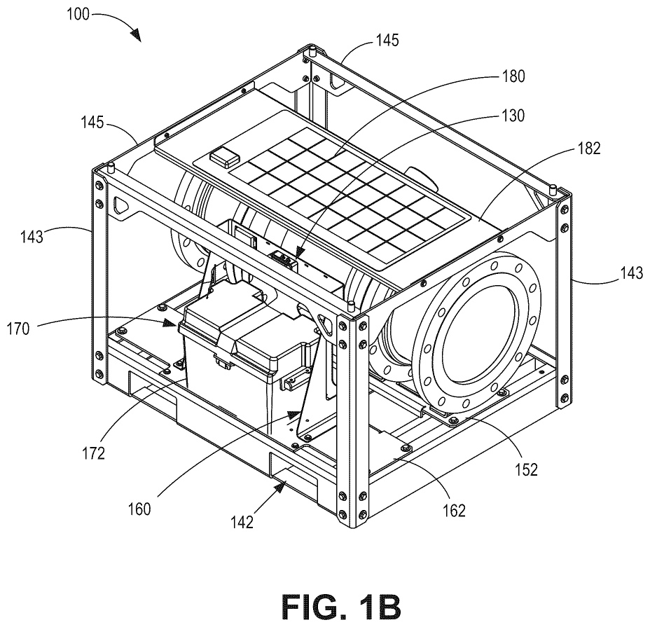

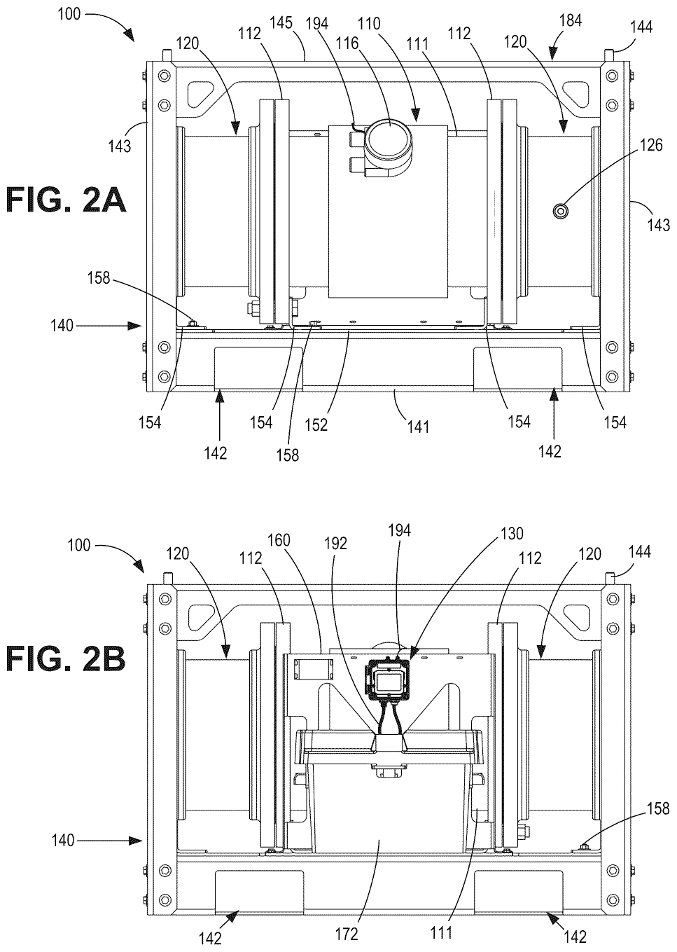

FIGS. 1A and 1B are front and rear isometric views of an exemplary embodiment of a portable flow meter assembly 100, according to an implementation described herein. FIGS. 2A and 2B are front and rear views of portable flow meter assembly 100, and FIG. 3 is a bottom or underside view of portable flow meter assembly 100. Referring collectively to FIGS. 1A-3, portable flow meter assembly 100 may include a flow meter 110, pipe section(s) 120, a monitoring device 130, a chassis 140, a base plate arrangement 150, an electrical panel 160, a battery 170, and a solar panel 180.

Flow meter 110 may include an in-line flow meter, such as an electromagnetic flow meter, to measure a fluid volume and/or fluid mass passing through a particular location during a specified time period. In other implementations, flow meter 110 may include a mechanical flow meter, a pressure flow meter, an optical flow meter, a vortex flow meter, a thermal mass flow meter, an ultrasonic flow meter, and/or another type of flow meter. Flow meter 110 may be provided in one of multiple available sizes to fit a piping system to be monitored. For example, flow meter assembly 100 may be sized for piping systems with nominal diameters between about 4 to 12 inches (i.e., 10.16 cm to 30.48 cm). It should be understood that flow meter assembly 100 may be sized for use with piping systems having larger or smaller sizes, as well. Flow meter 110 may include, for example, a measurement tube 111 and connecting flanges 112 on either end of measurement tube 111. Each of connecting flanges 112 may include a set of bolt holes 114. Flanges 112 and bolt holes 114 may be sized and oriented, for example, to meet one or more standardized interface requirements, such as a Society of Automotive Engineers (SAE) standard. Flow meter 110 may also include an electronics unit 116 mounted, for example, on measurement tube 111 to obtain flow rates of fluids passing through measurement tube 111. According to an implementation, electronics unit 116 may include, among other features, a display (e.g., light-emitting diodes (LED), a liquid-crystal display (LCD), etc.) to visually present a current and/or cumulative reading of flow meter 110.

One or more pipe sections 120 may be installed on either end of flow meter 110. Pipe sections 120 may protect flow meter 110 by limiting direct connections to flow meter 110 in the field. Instead, technicians may connect field piping (not shown) to the pipe sections 120, rather than directly to flow meter 110. Each of pipe sections 120 may include connecting flanges 122 with bolt holes 124 on either end. Bolt holes 124 may be configured to match a standardized arrangement of bolt holes 114 on flanges 112, for example. On one end, connecting flanges 122 may connect pipe sections 120 to connecting flanges 112 of flow meter 110. On an opposite end of pipe section 120, connecting flanges 122 may connect pipe sections 120 to corresponding flanges in the field piping.

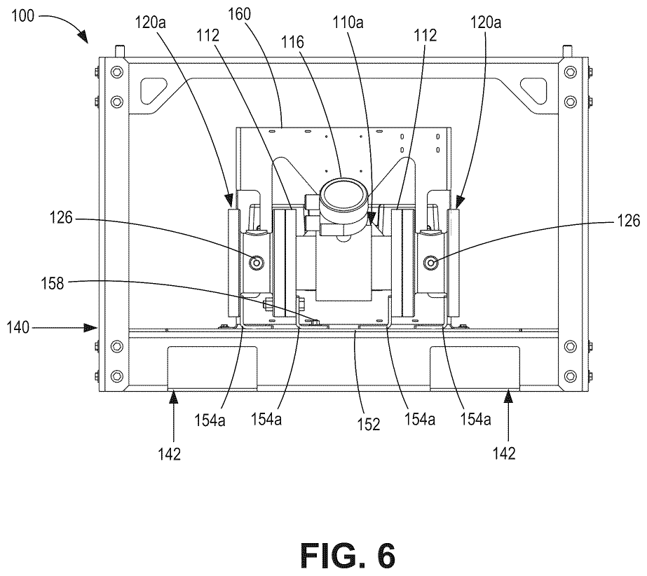

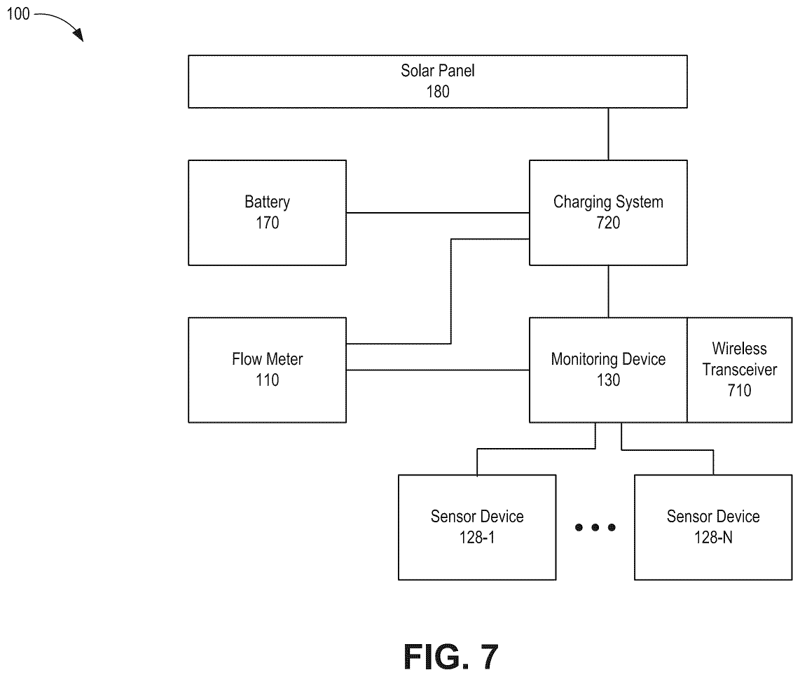

Pipe section 120 may include one or more tapped ports 126 (FIG. 6). Each tapped port 126 may provide a connection point for a sensor device 128 (FIG. 7) to be attached to a pipe section 120. For example, a tapped port 126 may include a threaded bore through which a sensor device 128 may be inserted/connected to detect properties within pipe section 120. Tapped ports 126 may be included in pipe sections upstream and/or downstream of in-line flow meter 110. Thus, sensor device 128 may be used to monitor conditions of fluid flow entering (e.g., upstream) or exiting (e.g., downstream) flow meter 110. Sensor devices 128 may include, for example, an acidity (e.g., pH) sensor, a salinity sensor, a pressure sensor, a temperature sensor, a level sensor, a turbidity sensor, a pressure switch, a vibration sensor, etc. In some implementations, sensor devices 128 may be incorporated with or directly connected to a monitoring device (e.g., monitoring device 130). In other implementations, sensor devices 128 may detect a monitored condition and generate an output value to monitoring device 130, as described further herein.

Monitoring device 130 may be configured to receive input from flow meter 110 and sensor devices 128. Monitoring device 130 may support flow monitoring and other data collection associated with flow meter 110, along with data uploading over a wireless network. In one implementation, monitoring device 130 may be an industrial internet-of-things (IIoT) device. Monitoring device 130 may be configured, for example, to accept hard wired inputs from flow meter 110 (e.g., wired connection 194) and/or sensor devices 128. In other aspects, monitoring device 130 may accept data from flow meter 110 and/or sensor devices 128 via wireless connections. In one implementation, monitoring device 130 may be powered by an internal (e.g., disposable) battery. In another implementation, monitoring device 130 may be powered by an external, rechargeable battery (e.g., battery 170) via a wired connection 192, for example. Monitoring device 130 may be used to supply power (e.g., from battery 170) to flow meter 110 and/or sensor devices 128.

Chassis 140 may include a frame made from metal and/or another type of structural material, such as a structural plastic, composite, etc. As an example, chassis 140 may be manufactured from stainless steel. As another example, chassis 140 may be manufactured from powder-coated steel, galvanized steel, aluminum, and/or another type of metal. Chassis 140 may provide structural support and secure flow meter 110, pipe section(s) 120, monitoring device 130, base plate arrangement 150, electrical panel 160, battery 170, and solar panel 180.

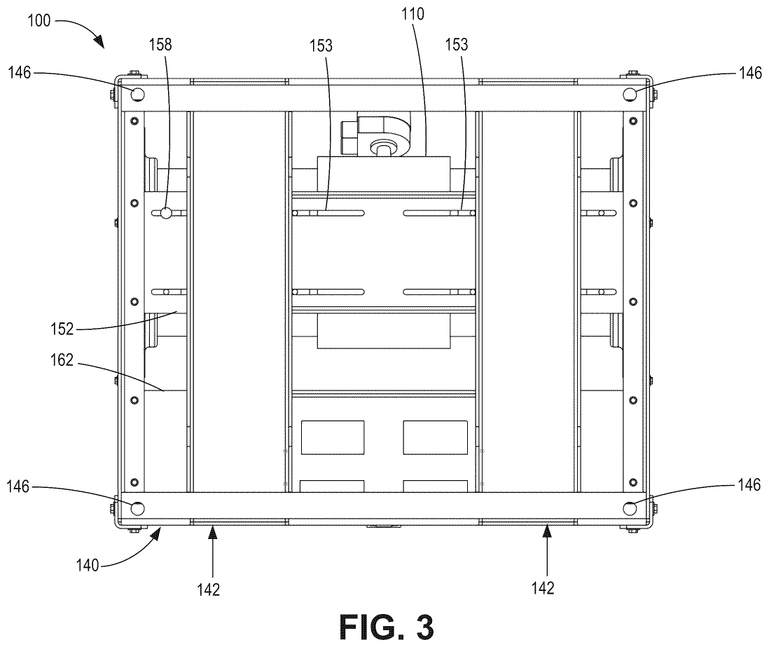

Chassis 140 may be assembled in the form of a skid structure with rectangular sides. As shown in FIG. 4, for example, in one implementation, chassis 140 may include a base section 141 that supports multiple corner brackets 143 in a vertical orientation. Cross brackets 145 may be connected to corner brackets 143 to form a top frame of chassis 140. According to an implementation, chassis 140 may be substantially in the form of a rectangular prism. In different implementations, the sides and/or support beams (e.g., base section 141, corner brackets 143, cross brackets 145, etc.) may be manufactured from structural tubing beams having a rectangular cross-section, H-profile beams, C-profile beams, L-profile beams, solid bar beams, and/or other types of beams.

Chassis 140 may be configured as a stackable structure, such that multiple flow meter assemblies 100 may be vertically stacked (e.g., for storage, transport, etc.). Fork pockets 142 may be included along a base of chassis 140 to permit lifting and transport of flow meter assembly 100 via, for example, a forklift or another lifting device. Chassis 140 may also include alignment pins 144, which may extend upwards, for example, from upper corners of chassis 140. Alignment pins 144 may be configured to align with openings 146 in an underside of chassis 140, such that alignment pins 144 of one chassis 140 may be received into openings 146 (FIG. 3) of another chassis 140 when flow meter assemblies 100 are stacked upon each other.

Chassis 140 may be configured to support flow meter 110 and corresponding pipe section(s) 120 of different sizes. In some implementations, chassis 140 may include adjustable base plate arrangement 150 configured to support the flow meter 110 and pipe sections 120 within chassis 140. Adjustable base plate arrangement 150 may include an adaptor plate 152, a set of support brackets 154, and a set of hold-down bolts 158.

Adaptor plate 152 may be formed from a steel plate that may be shaped/bent into multiple planes. Adaptor plate 152 may be bolted, or otherwise secured, to beams of chassis 140 on a substantially horizontal plane in a lower portion of chassis 140.

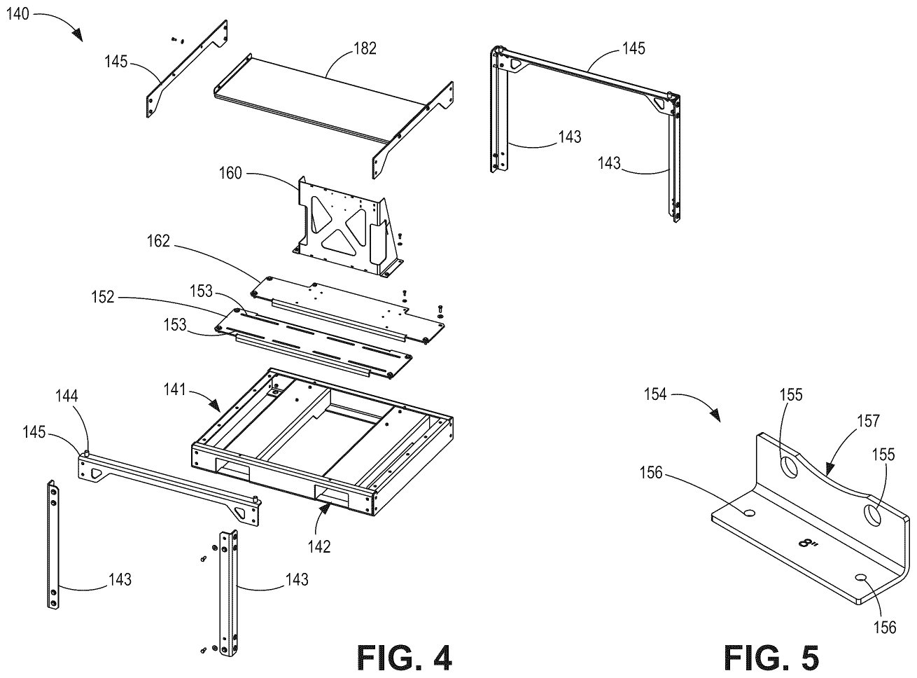

Support brackets 154 may include metal structures that connect adaptor plate 152 to flow meter 110 and/or piping sections 120. Support brackets 154 may include, for example, a substantially L-shaped bend to form a vertical surface with a set of attachment holes 155 and a horizontal surface with a set of mounting holes 156. Attachment holes 155 may be arranged to match the spacing of at least some bolt holes 114 and/or bolt holes 124. Support brackets 154 may be provided in different sizes to accommodate different sizes of flow meter 110. For example, support brackets 154 may be configured to connect to flow meter 110 and/or piping sections 120 with 4-, 6-, 8-, 10-, and 12-inch (i.e., 10.16-, 15.24-, 20.32-, 25.4-, and 30.48-centimeter) nominal diameters. In some implementations, as shown in FIG. 5, the vertical surface of support bracket 154 may include a curved cutout 157 with a radius that corresponds to an outside radius of flow meter 110 and/or piping sections 120.

Adaptor plate 152 may include mounting slots 153 that are configured to align with mounting holes 156 of support brackets 154 and to receive hold-down bolts 158 therethrough. For example, adaptor plate 152 may include mounting slots 153 aligned parallel to an intended axis of the in-line flow meter. When hold-down bolts 158 are inserted through mounting holes 156 and mounting slots 153, adaptor plate 152 may be bolted to flange 112 and/or flange 122 to secure flow meter 110 to adaptor plate 152.

Electrical panel 160 may be secured to chassis 140. In one implementation, a baseplate 162 may be installed across a portion of base section 141 to receive electrical panel 160. Electrical panel 160 may physically support monitoring device 130 and facilitate wired connections to battery 170, flow meter 110, and/or sensor devices 128. Electrical panel 160 and baseplate 162 may also form an alcove or opening for supporting battery 170. According to an implementation, electrical panel 160 may also include a charging system. In one implementation, electrical panel 160 may include clips, hooks, or holes to allow cables to be secured within the area of chassis 140.

Battery 170 may include a rechargeable battery, such as a 12 Volt rechargeable battery. Battery 170 may include a flooded lead-acid battery, a sealed valve regulated lead-acid (VRLA) battery, an absorbent glass mat (AGM) battery, a gel battery, a lithium-ion battery, a nickel-metal hydride battery, and/or another type of battery 170. Battery 170 may power the components of flow meter assembly 100 (e.g., flow meter 110, sensor devices 128, and/or monitoring system 130). Battery 170 may be charged from solar panel 180 using, for example, a charging system included in the flow meter assembly 100. Battery 170 may be mounted within chassis 140 and include a wired connection to the charging system, for example.

In some implementations, a battery enclosure 172 (FIG. 1B) may be provided for battery 170. Battery enclosure 172 may provide a dust-resistant and water-spray resistant enclosure to protect battery 170. Battery enclosure 172 may be manufactured from a structural plastic material, metal, composite, and/or another type of material. In some implementations, battery enclosure 172 may meet one or more industrial standards (e.g., the International Electrotechnical Commission (IEC), National Electrical Manufacturers Association (NEMA), etc.) for water-proof submersion or spray.

Solar panel 180 may include a set of solar cells to capture sunlight and charge battery 170 and/or provide power to components of flow meter assembly 100 when the power supplied by battery 170 is insufficient to meet the power demand. Solar panel 180 may include monocrystalline solar cells, polycrystalline solar cells, thin film solar cells, and/or another type of solar cells. The type and/or size of solar panel 180 may be selected to meet the maximum power demand of the components of the pump monitoring device indefinitely or over prolonged periods of time (e.g., days or weeks) if battery 170 fails. For example, in some implementations, solar panel 180 may have a capacity to produce 40 Watts of power or more.

Solar panel 180 may be mounted within a solar panel support 182 incorporated in or mounted to a top section of chassis 140. Solar panel support 182 may provide structural support to solar panel 180 and secure solar panel 180 to chassis 140. In one implementation, solar panel support 182 may provide a flat smooth surface to receive an adhesive solar panel 180. In some implementations, solar panel support 182 may be formed from a steel plate that may be shaped/bent into multiple planes. In other implementations, solar panel support 182 may be manufactured from the same type of beam as chassis 140. In still other implementations, solar panel support 182 may be manufactured from a different type of structural material, such as, for example, perforated flat beams, square tubes, strut channels, L-shaped angles, etc. In still other implementations, solar panel 180 may be formed from a foldable, flexible panel that can be unfolded and used as needed.

In some implementations, solar panel support 182 may be positioned on chassis 140 in a position that protects solar panel 180 from contact if another flow meter assembly 100 is stacked upon chassis 140. For example, solar panel support 182 may position solar panel 180 so that solar panel 180 is recessed below a top plane 184 (FIG. 2B) of chassis 140 (e.g., a plane that is defined by the highest points of corner brackets 143 and cross brackets 145). In some implementations, the angle of solar panel support 182 may be fixed (e.g., at 0 degrees) with respect to the plane of top frame 184. In other implementations, solar panel support 182 may be adjustable so that the angle of solar panel 180 may be adjusted with respect to chassis 140 in order to position solar panel 180 to maximize the amount of sunlight absorbed by solar panel 180.

Although FIGS. 1A-5 show exemplary components of flow meter assembly 100, in other implementations, flow meter assembly 100 may include fewer components, different components, differently arranged components, or additional components than depicted in FIGS. 1A-5. Additionally, or alternatively, one or more components of flow meter assembly 100 may perform functions described as being performed by one or more other components of flow meter assembly 100. For example, in another implementation, some functions of monitoring device 130 and water meter 110 may be combined.

FIG. 6 is a front view of a portable flow meter assembly 100 according to another implementation. In the implementation of FIG. 6, an in-line flow meter 110a is sized for a certain field application and portable flow meter assembly 100 may be adapted to accommodate flow meter 110a. For example, in contrast with the arrangement of FIG. 2A, flow meter 110a may be configured to measure flow for a smaller pipe diameter. More particularly, chassis 140 may be adapted to mount flow meter 110a and corresponding pipe sections 120a using brackets 154a. Brackets 154a may be sized to match the diameter and flange design of flow meter 110a and pipe sections 120a. Slots 153 in adaptor plate 152 may be configured to accommodate a different (e.g., more compact) axial length of flow meter 110a and pipe sections 120a, such that bolts 158 may be inserted through adaptor plate 152 to secure flow meter 110a. According to another implementation, different bracket sizes 154a may be used with differently sized-flow meters 110a and pipe sections 120a to mount flow meters 110a within chassis 140.

FIG. 7 is a block diagram illustrating connections of exemplary components of portable flow meter assembly 100, according to an implementation described herein. As shown in FIG. 7, portable flow meter assembly 100 may include flow meter 110, sensor devices 128 (referred to herein collectively as “sensor devices 128” and generically as “sensor device 128”), monitoring device 130 including a wireless transceiver 710, battery 170, solar panel 180, and a charging system 720. According to an implementation, one or more of monitoring device 130, wireless transceiver 710, and/or charging system 720 may be installed on a printed circuit board, an etched wiring board, or a printed circuit assembly.

According to an implementation, flow meter 110 and/or sensors 128 may transfer measurement data to monitoring device 130 via a wired connection (e.g., wired connector 194). According to another implementation, flow meter 110 and/or sensors 128 may transfer measurement data to monitoring device 130 via wireless signals, using a short-range wireless standard (e.g., based on the Institute of Electrical and Electronics Engineers (IEEE) 802.15 suite of standards or another wireless standard). Monitoring device 130 may receive measurement data from flow meter 110 and/or sensors 128. For example, monitoring device 130 may receive continuous fluid flow readings or periodic fluid flow readings from flow meter 110. According to one implementation, monitoring device 130 may be configured to temporarily store, upload, and/or generate alert signals based on the fluid flow readings.

According to an implementation, monitoring device 130 may control the overall operation or a portion of operation(s) performed by flow meter assembly 100. Monitoring device 130 may include one or more processors microprocessors, data processors, co-processors, application specific integrated circuits (ASICs), controllers, programmable logic devices, chipsets, field-programmable gate arrays (FPGAs), application specific instruction-set processors (ASIPs), system-on-chips (SoCs), central processing units (CPUs) (e.g., one or multiple cores), microcontrollers, and/or some other type of component that interprets and/or executes instructions and/or data. Monitoring device 130 may also include one or more memory devices to store the instructions and/or data.

Monitoring device 130 may include, or be connected to, a wireless transceiver 710. Wireless transceiver 710 may include a cellular radio transceiver, which may operate according to a cellular standard that enables communication with a wireless network, such as a network using the Third Generation Partnership Project (3GPP) Fourth Generation (4G), Fifth Generation (5G), and/or Sixth Generation (6G) mobile wireless standards. Furthermore, wireless transceiver 710 may be configured for one or more machine-to-machine (M2M) communications methods, such as enhanced Machine-Type Communication (eMTC), Narrow Band IoT (NB-IOT), etc. Additionally, wireless transceiver 710 may include a radio transceiver for a wireless personal area network (e.g., using IEEE 802.15 standards or Bluetooth®), a GPS receiver, and/or a radio transceiver operating in an unlicensed spectrum (e.g., 900 MHz, 2.4 GHz).

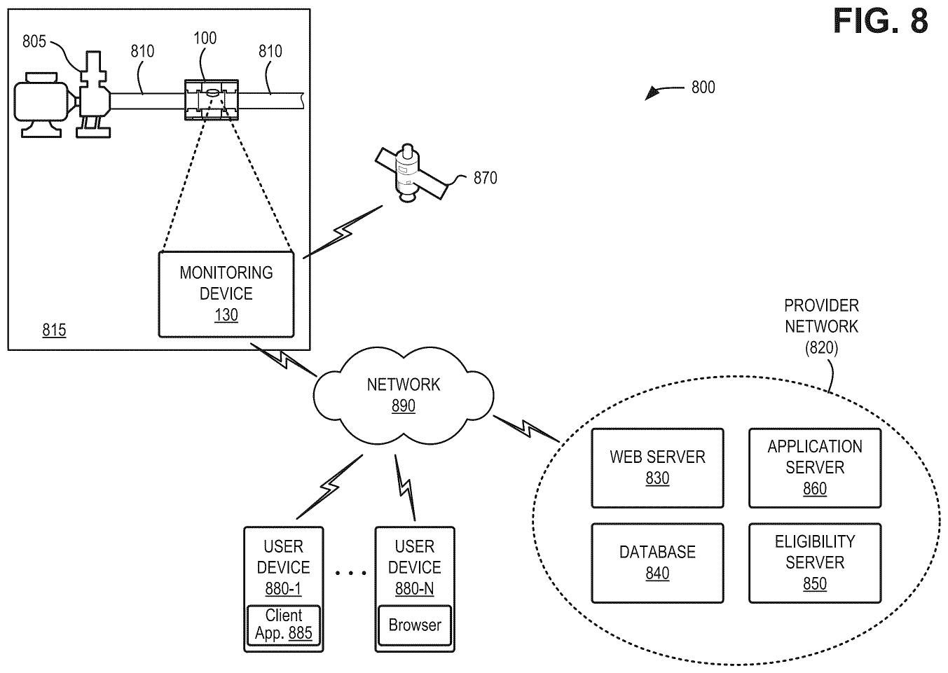

Monitoring device 130 may collect sample readings from flow meter 110, sensors 128 connected to sensor ports 126, battery 170, and/or charging system 720. In one implementation, monitoring device 130 may determine sampling rates and available functions based on whether power from battery 170 or solar panel 180 is being used. For example, if power from battery 170 is available, monitoring device 130 may sample flow rates more frequently. Monitoring device 130 may cause sample data to be sent to a provider network 820 (FIG. 8) on a periodic basis. Monitoring device 130 may also be programmed to detect if readings from any sensors 128 and/or flow meter 110 exceed a predetermined threshold value and generate an alert signal when a threshold is exceeded.

Charging system 720 may power devices of flow meter assembly 100 and/or charge battery 170 using solar panel 180. Charging system 720 may manage power usage of flow meter 110 and/or monitoring system 130. For example, charging system 720 may monitor the power capacity (e.g., voltage) of battery 170, power consumption of flow meter 110 and/or monitoring system 130, and/or power supplied by solar panel 180. Charging system 720 may be configured to use power from battery 170 to power flow meter 110 and/or monitoring system 130 when the battery power is above a battery power threshold, and use power from solar panel 180 to power flow meter 110 and/or monitoring system 130 and/or charge battery 230, when the battery 170 is associated with a battery power below the battery power threshold. The battery power thresholds may be configured for a particular system/flow meter 110 and stored by charging system 720.

Although FIG. 7 shows exemplary components of flow meter assembly 100, in other implementations, flow meter assembly 100 may include fewer components, different components, differently arranged components, or additional components than depicted in FIG. 7. Additionally, or alternatively, one or more components of flow meter assembly 100 may perform functions described as being performed by one or more other components of flow meter assembly 100.

FIG. 8 is a block diagram illustrating an exemplary environment 800 in which systems and/or methods described herein may be implemented. As illustrated, environment 800 may include pump equipment 805 that pumps or draws fluid through a field piping 810 that is monitored via flow meter assembly 100, which includes monitoring device 130. Flow meter assembly 110 may be installed upstream or downstream of pump equipment 805. Pump equipment 805, field piping 810, and flow meter assembly 100 may be distributed throughout a customer premises 815, such as an industrial, commercial, or agricultural environment, for example. Environment 800 may also include a provider network 820 with a web server 830, a database 840, an eligibility server 850, and an application server 860; a global positioning system (GPS) 870; and user devices 880-1 through 880-N interconnected by a network 890. Components of environment 800 may be connected via wired and/or wireless links.

Provider network 820 may include network devices, computing devices, and other equipment to provide services, including services for customers with monitoring devices 130. For example, devices in provider network 820 may supply backend services to user devices 880 for remotely monitoring pump equipment 805 via flow meter assembly 100. Provider network 820 may include, for example, one or more private Internet Protocol (IP) networks that use a private IP address space. Provider network 820 may include a local area network (LAN), an intranet, a private wide area network (WAN), etc. According to an implementation, provider network 820 may use vendor-specific protocols to support IIoT management. In another implementation, provider network 820 may include a hosting platform that provides an IIOT data service. The IIOT data service may include receiving packets that are transmitted by monitoring devices 130 and implementing models to collect, store, analyze, and/or present event data from monitoring devices 130. The hosting platform may also provide data-driven applications and/or analytics services for user devices 880 that owners of monitoring devices 130 (or parties responsible for managing monitoring devices 130) may use. Examples of hosting platforms that may use different protocols and commands include Amazon® Web Services (AWS), Microsoft Azure®, IBM Watson®, Verizon® ThingSpace®, etc. Although shown as a single element/network in FIG. 8, provider network 820 may include a number of separate networks.

Web server 830 may include one or more network or computational devices to manage service requests from eligible user devices 880. In one implementation, web server 830 may provide an application (e.g., an event data management application) and/or instructions to user device 880 to enable user device 880 to receive and respond to information related to flow meter assembly 100. In another implementation, as described further herein, web server 830 may provide multiple types of browser-based user interfaces to facilitate individual pump monitoring, system monitoring, receive alerts, receive notifications, etc. Web server 830 may receive settings from user devices 880, may process/collate the received settings, and may forward the settings to application server 860 for implementation.

Database 840 may include one or more databases or other data structures to store data uploads from monitoring devices 130, reporting/monitoring configurations, device registrations (e.g., provided by user devices 880 via web server 830) and/or user registrations. In one implementation, database 840 may also store data retrieved from and/or used by eligibility server 850.

Eligibility server 850 may include one or more network or computational devices to provide backend support for authorizing monitoring devices 130 and/or user devices 880 to use provider network 820. For example, eligibility server 850 may perform a provisioning process for a monitoring device 130, including authentication, registration, and activation in network 890. Additionally, or alternatively, eligibility server 850 may store identification information for registered users and/or user devices 880. The information may be used to verify that a particular user/user device 880 has access to services and/or information provided by provider network 820. Upon verifying eligibility of a user/user device 880, eligibility server 850 may, for example, provide access to other devices in provider network 820.

Application server 860 may include one or more network or computational devices to perform services accessed through web server 830. For example, application server 860 may manage downloading applications provided to user devices 880, may process incoming data (e.g., from monitoring devices 130) for storage in database 840, and/or provide configuration information to monitoring devices 130. According to an implementation, application server 860 may use a series of application programming interfaces (APIs) to send and receive data from monitoring devices 130. For example, monitoring device 130 may forward to application server 860 periodic uploads of flow rate data from flow meter 110. In other aspects, monitoring device 130 may forward to application server 860 real-time alerts for low (or high) flow rate readings from flow meter 110. Application server 860 may store historical data records from flow meter 110 in database 840. Application server 860 may also report alerts to registered users.

Positioning system 870 may include one or more devices configured to provide location information to monitoring devices 130. In some implementations, location information may include, for example, GPS information or another form of global navigation satellite system (GNSS) information. In one implementation, positioning system 870 may include one or more cellular towers, wherein user devices 880 may retrieve location information in the form of cellular tower triangulation information. Additionally, or alternatively, positioning system 870 may include a GPS satellite to determine a location of monitoring device 130 and/or flow meter assembly 100.

User device 880 includes a device that has computational and wireless communication capabilities. For example, user device 880 may be implemented as a mobile device, a portable device, a stationary device, a device operated by a user, or a device not operated by a user. For example, user device 880 may be implemented as a smartphone, a computer, a tablet, a wearable device, or some other type of wireless device. According to various exemplary embodiments, user device 880 may be configured to execute various types of software (e.g., applications, programs, etc.). As described further herein, user device 880 may download and/or register a client application 885. As described further herein, the client application 885 (or “app”) may be designed to access, from provider network 820, data reported by monitoring devices 130. For example, client application 885 may provide a user interface (UI) to solicit configuration settings and data requests (e.g., flow rate data requests) from a user. In another implementation, user device 880 may use a web browser to connect to web server 830 and perform similar functions of client application 885.

Network 890 may include one or more wired, wireless, and/or optical networks that are capable of receiving and transmitting data, voice and/or video signals. For example, network 890 may include one or more access networks, IP multimedia subsystem (IMS) networks, core networks, or other networks. The access network may include one or more wireless networks and may include a number of transmission towers for receiving wireless signals and forwarding wireless signals toward the intended destinations. The access network may include a wireless communications network that connects subscribers (e.g., monitoring devices 130, user devices 880, etc.) to other portions of network 890 (e.g., the core network). In one example, the access network may include a long-term evolution (LTE) or Fourth Generation (4G) network. In other implementations, the access network may employ other cellular broadband network standards such as 3rd Generation Partnership Project (3GPP) 5G, 6G, and future standards. Network 890 may further include one or more satellite networks, one or more packet switched networks, such as an IP-based network, a local area network (LAN), a wide area network (WAN), a personal area network (PAN) (e.g., a wireless PAN), a wireless local area network (WLAN), an intranet, the Internet, or another type of network that is capable of transmitting data.

In FIG. 8, the particular arrangement and number of components of environment 800 are illustrated for simplicity. In practice there may be more flow meter assemblies 100 with monitoring devices 130, provider networks 820, web servers 830, databases 840, eligibility servers 850, application servers 860, positioning systems 870, user devices 880, and/or networks 890.

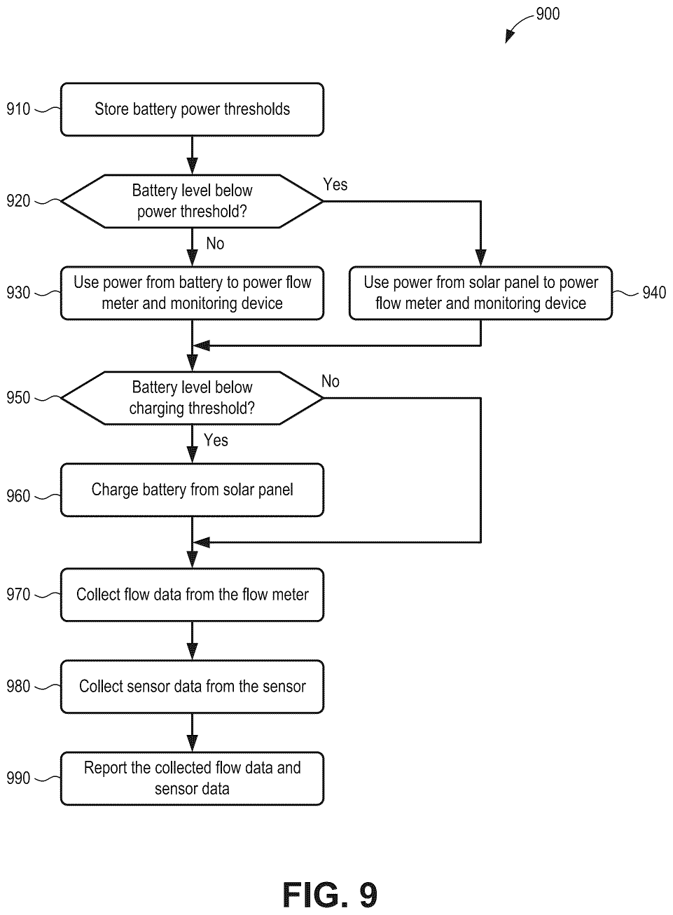

FIG. 9 is a flow diagram of a process 900 that may be performed by portable flow meter assembly 100, in accordance with an implementation. Process 900 may include storing battery power thresholds (block 910) and determining if a battery level is below a power threshold (block 920). For example, charging system 720 may store battery power thresholds and monitor battery power (e.g., voltage) in battery 170 to detect if power levels drop below a power threshold.

If the battery level is not below a power threshold (block 920-No), process 900 may include using power from the battery to power the flow meter (block 930). For example, when battery 170 is associated with a battery power above a battery power threshold, charging system 720 may use power from battery 170 to power flow meter 110 and monitoring device 130.

If the battery level is below a power threshold (block 920—Yes), process 900 may include using power from the solar panel to power the flow meter (block 940). For example, when battery 170 is associated with a battery power below a battery power threshold, charging system 720 may use power from solar panel 180 to power flow meter 110 and monitoring device 130. According to an implementation, monitoring device 130 may not provide power to sensor device(s) 128 when monitoring device 130 is powered directly from solar panel 180.

Process 910 may include determining if a battery level is below a charging threshold (block 950). For example, charging system 720 may monitor battery power (e.g., voltage) in battery 170 to detect if power levels drop below a charging threshold (e.g., a level that may be higher than the power threshold).

If the battery level is below the charging threshold (block 950—Yes), process 900 may include charging the battery from the solar panel (block 960). For example, charging system 720 may use solar panel 180 to charge battery 170 when battery power below a battery charging threshold.

Process 900 may further include collecting flow data from the flow meter (block 970), collecting sensor data from a sensor (block 980), and reporting the collected flow data and sensor data (block 990). For example, monitoring device 130 may collect flow data from flow meter 110, collect sensor data from a sensor device 128 that is connected to the pipe section 120, and report the collected flow data and sensor data via wireless transceiver 710 in the monitoring device 130.

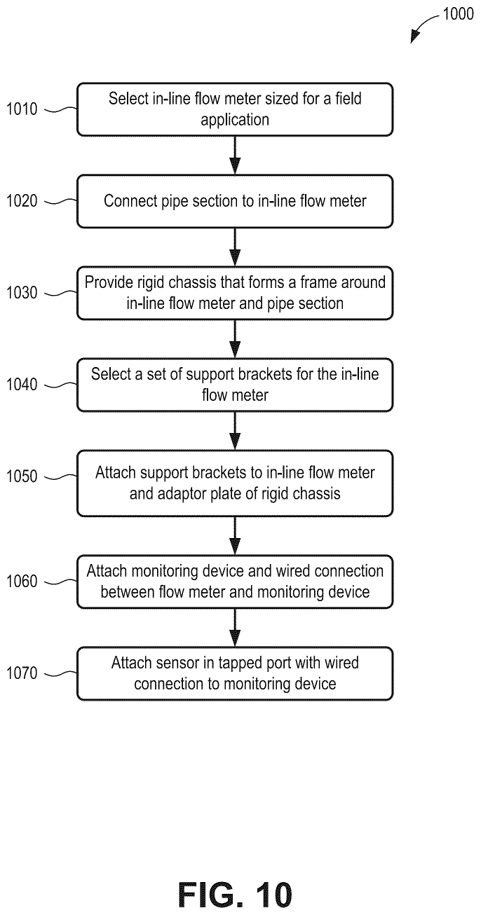

FIG. 10 is flow diagram of a process 1000 for configuring a portable flow meter assembly 100, in accordance with an implementation. Process 1000 may include selecting an in-line flow meter sized for a field application (block 1010), connecting a pipe section to the in-line flow meter (block 1020), and providing a rigid chassis that forms a frame around the in-line flow meter and the pipe section (block 1030). For example, a technician may select an in-line flow meter 110 sized for a field application. The in-line flow meter 110 may include connecting flanges 112 that include a set of flange holes 114. The technician may connect a pipe section 120 to the in-line flow meter. Pipe section 120 may include a connecting flange 122 configured to connect to one of connecting flanges 112. Pipe section 10 may include at least one tapped port 126 configured to receive a sensor device 128. A rigid chassis 140 may be selected. Chassis 140 may form a frame around in-line flow meter 110 and pipe section 120. Rigid chassis 140 may include an adjustable base plate arrangement 150 configured to support in-line flow meter 110 and pipe section 120 within the rigid chassis 140. Adjustable base plate arrangement 150 may include adaptor plate 152 with slots 153 aligned parallel to an axis of the installed in-line flow meter 110.

Process 1000 may further include selecting a set of support brackets for the in-line flow meter (block 1040), attaching support brackets to in-line flow meter and adaptor plate of rigid chassis (block 1050), attaching a monitoring device and wired connection between flow meter and monitoring device, and attaching a sensor in the tapped port with wired connection to the monitoring device (block 1070). For example, a technician may select a set of support brackets 154 sized for supporting in-line flow meter 110. Each support bracket 154 may include holes 156 configured to align with the mounting slots 153 and holes 154 configured to align with at least two flange holes 114 of flange 112. The technician may attach the support brackets 154 to in-line flow meter 110 and adaptor plate 152. The technician may also attach a wired connection between flow meter 110 and the monitoring device 130. In some implementations, the technician may also attach the sensor 128 to tapped port 126 (e.g., threading the sensor into port 126) and attach a wired connection between sensor 128 and monitoring device 130.

As set forth in this description and illustrated by the drawings, reference is made to “an exemplary embodiment,” “an embodiment,” “embodiments,” etc., which may include a particular feature, structure, or characteristic in connection with an embodiment(s). However, the use of the phrase or term “an embodiment,” “embodiments,” etc., in various places in the specification does not necessarily refer to all embodiments described, nor does it necessarily refer to the same embodiment, nor are separate or alternative embodiments necessarily mutually exclusive of other embodiment(s). The same applies to the term “implementation,” “implementations,” etc.

The foregoing description of embodiments provides illustration, but is not intended to be exhaustive or to limit the embodiments to the precise form disclosed. Accordingly, modifications to the embodiments described herein may be possible. For example, various modifications and changes may be made thereto, and additional embodiments may be implemented, without departing from the broader scope of the invention as set forth in the claims that follow. The description and drawings are accordingly to be regarded as illustrative rather than restrictive.

The terms “a,” “an,” and “the” are intended to be interpreted to include one or more items. Further, the phrase “based on” is intended to be interpreted as “based, at least in part, on,” unless explicitly stated otherwise. The term “and/or” is intended to be interpreted to include any and all combinations of one or more of the associated items. The word “exemplary” is used herein to mean “serving as an example.” Any embodiment or implementation described as “exemplary” is not necessarily to be construed as preferred or advantageous over other embodiments or implementations.

Use of ordinal terms such as “first,” “second,” “third,” etc., in the claims to modify a claim element does not by itself connote any priority, precedence, or order of one claim element over another, the temporal order in which acts of a method are performed, the temporal order in which instructions executed by a device are performed, etc., but are used merely as labels to distinguish one claim element having a certain name from another element having a same name (but for use of the ordinal term) to distinguish the claim elements.

No element, act, or instruction used in the description of the present application should be construed as critical or essential to the invention unless explicitly described as such.

What is claimed is:

1. A portable flow meter assembly, comprising:
an in-line flow meter including first connecting flanges, wherein each of the first connecting flanges include a set of flange holes;
a pipe section including a second connecting flange configured to connect to one of the first connecting flanges, wherein the pipe section includes at least one port configured to receive a sensor;
a rigid chassis that forms a frame around the in-line flow meter and the pipe section;
a battery mounted within the rigid chassis and including a wired connection to the in-line flow meter; and
an adjustable base plate arrangement configured to support the in-line flow meter and the pipe section within the rigid chassis, the adjustable base plate arrangement including:
an adaptor plate including slots aligned substantially parallel to an axis of the in-line flow meter,
a set of support brackets, each support bracket including first holes configured to align with the slots, and second holes configured to align with at least two flange holes of the set of flange holes, and
a set of bolts configured to secure the set of support brackets through the first holes along the slots,
wherein the rigid chassis includes a set of pockets, integral with a base of the rigid chassis, the pockets configured to receive prongs of a lifting device.

2. The portable flow meter assembly of claim 1, wherein the rigid chassis is configured to receive a second portable flow meter assembly stacked on the rigid chassis, and wherein the rigid chassis further comprises alignment pins for insertion into holes of the second portable flow meter assembly.

3. The portable flow meter assembly of claim 1, further comprising:
a solar panel secured to the rigid chassis; and
a charging system to charge the battery using the solar panel.

4. The portable flow meter assembly of claim 3, further comprising:
a solar panel support mounted to the rigid chassis, wherein the solar panel support positions the solar panel below a plane of a top of the rigid chassis.

5. The portable flow meter assembly of claim 1, further comprising:
the sensor, wherein the sensor includes one of an acidity sensor, a salinity sensor, a pressure sensor, a temperature sensor, a level sensor, a turbidity sensor, a pressure switch, or a vibration sensor.

6. The portable flow meter assembly of claim 1, further comprising:
a monitoring device mounted within the rigid chassis, wherein the monitoring device is configured to receive data from the in-line flow meter and the sensor.

7. The portable flow meter assembly of claim 6, wherein the monitoring device is configured to output a current reading of the in-line flow meter.

8. The portable flow meter assembly of claim 6, wherein the monitoring device is configured to receive the data from the in-line flow meter and the sensor via wired communications interfaces.

9. The portable flow meter assembly of claim 6, wherein the monitoring device is configured to receive the data from the in-line flow meter via a wireless communications interface.

10. The portable flow meter assembly of claim 6, wherein the monitoring device further includes a wireless transceiver configured to transmit the data to a network on a periodic basis.

11. The portable flow meter assembly of claim 6, further comprising:
an electrical panel mounted within the rigid chassis, wherein the electrical panel is configured to support the monitoring device.

12. A method performed by a portable flow meter assembly that includes a flow meter and a pipe section connected in-line with the flow meter, the method comprising:
using power from a battery to power the flow meter, when the battery is associated with a first battery power that is above a battery power threshold;
using power from a solar panel to power the flow meter, when the battery is associated with a second battery power that is below the battery power threshold;
charging the battery from the solar panel when the battery is associated with the second battery power that is below the battery power threshold;
collecting flow data from the flow meter;
collecting sensor data from a sensor that is connected to the pipe section; and
reporting the collected flow data and the sensor data via a wireless transceiver included in a monitoring device.

13. The method of claim 12, wherein collecting the sensor data further comprises:
collecting one or more of acidity data, salinity data, pressure data, temperature data, fluid level data, turbidity data, or vibration data.

14. The method of claim 12, wherein collecting the sensor data further comprises:
collecting the sensor data at a location downstream of the flow meter.

15. The method of claim 12, wherein collecting the sensor data further comprises:
collecting the sensor data at a location upstream of the flow meter.

16. A method, comprising:
selecting an in-line flow meter sized for a field application, the in-line flow meter including first connecting flanges, wherein each of the first connecting flanges includes a set of flange holes;
connecting to the in-line flow meter a pipe section, the pipe section including a second connecting flange configured to connect to one of the first connecting flanges, wherein the pipe section includes at least one port configured to receive a sensor;
providing a rigid chassis that forms a frame around the in-line flow meter and the pipe section, the rigid chassis including an adjustable base plate arrangement configured to support the in-line flow meter and the pipe section within the rigid chassis, the adjustable base plate arrangement including an adaptor plate with slots aligned parallel to an axis of the in-line flow meter,
selecting a set of support brackets for supporting the in-line flow meter, each support bracket including first holes configured to align with the slots, and second holes configured to align with at least two flange holes of the set of flange holes; and
attaching the set of support brackets to the in-line flow meter and the adaptor plate.

17. The method of claim 16, wherein the rigid chassis further includes a monitoring device configured to receive readings from the in-line flow meter, and wherein the method further comprises:
attaching a wired connection between the in-line flow meter and the monitoring device.

18. The method of claim 16, wherein the rigid chassis further includes a monitoring device configured to receive readings from a sensor device, and wherein the method further comprises:
attaching the sensor device to the port, and
attaching a wired connection between the sensor device and the monitoring device.

19. The method of claim 16, wherein the rigid chassis further includes a monitoring device configured to receive readings from the in-line flow meter, and wherein the method further comprises:
mounting a battery within the rigid chassis; and
attaching the monitoring device to the battery.
